(19) United States
(12) Patent Application Publication
(10) Pub. No.: US 2006/0141121 A1
(43) Pub. Date: Jun. 29, 2006

(54) Vegetable article, product containing the same and process for producing vegetable article

(75) Inventor: Masatoshi Yoshikawa, Toyama (JP)

Correspondence Address: FISH & RICHARDSON P.C., P.O. BOX 1022, MINNEAPOLIS, MN, 55440-1022, US

(73) Assignee: Toyo Boseki Kabushiki Kaisya, Osaka (JP)

(21) Appl. No.: 10/531,525

(22) PCT Filed: Oct. 20, 2003
(86) PCT No.: PCT/JP03/13409

§ 371 Date: Nov. 2, 2005

(30) Foreign Application Priority Data
Oct. 31, 2002 (JP) 2002-318268

(51) Int. Cl. A23L 1/212

(52) U.S. Cl. 426/615

(57) ABSTRACT

The present invention is intended to provide a vegetable article which sustain initial characteristics inherent to a product with the use of vegetable articles such as hygroscopicity, texture, favorable smell and appearance and in which deformation, color change and emission of an unpleasant smell due to laundry or water washing are inhibited; a product containing the vegetable article; and a process for producing the vegetable article. To achieve this object, the following constitution is employed. Namely, a vegetable article has been subjected to a crosslinking treatment by using a crosslinking agent so as to inhibit worsening in the initial characteristics such as moisture content, bulk density and lightness. A product contains the above vegetable article. A process for producing the vegetable article characterized in that a crosslinking reaction with the use of a crosslinking agent is carried out to inhibit worsening in the initial characteristics of the vegetable article.

### TECHNICAL FIELD

The present invention relates to vegetable articles such as a leaf, a stem, a trunk, a vine, a fruit, a husk and a fiber aggregate collecting therefrom of a plant such as rush grass, rice plant, luffa, buckwheat, soybean, bamboo, timber or sea grass; products, for example, household articles such as a rush mat, a pillow, a floor cushion, a reed screen, a colander and a sponge and furniture such as a chair, a wardrobe and a desk made of the vegetable articles; and a process for producing the vegetable articles. More specifically, the present invention relates to vegetable articles in which these vegetable article-containing products can be laundered or washed with water at home, a product containing the same, and a process for producing the same.

### BACKGROUND ART

Conventionally, as household goods, furniture, interior goods or bedclothes, products utilizing a natural vegetable article have been used well. However, these vegetable article-containing products have a problem that, when they are washed with water, color change, deformation and dimensional change are easily caused. Further, since these vegetable products easily contain moisture, a moisture content after washing with water is high and it takes a long time to dry them. Therefore, there is also a problem that, when stained by use, they can not be simply washed. In addition, Japanese unexamined patent application No. Hei 10-165277 describes a technique regarding a buckwheat husk for a pillow which is dried by steaming with water steam at a temperature of 100° C. or more in a autoclave. However, this technique is entirely for giving an insect proof effect to the buckwheat husk. A buckwheat husk pillow is a highly popular pillow because of high moisture absorption and suitable cushion property possessed by a buckwheat husk. However, an actual buckwheat husk pillow has a problem that it is dried with difficulty when laundered, it has an unpleasant smell, and its height is changed. Consequently, it has been said that the pillow can not be laundered at home. In addition, since a sleeping rush mat made of rush grass is cool and comfortable when used in summer, many people like it nowadays. However, there is a problem that, when it is stained and washed with water, a surface becomes irregular and rush grass turns black; therefore, it can not be washed. These problems are due to that since a vegetable article contains cellulose, hemicellulose, lignin and the like as a main component, the article is swollen and deformed when wetted with water. Further, since many of these vegetable articles are used by only drying after collection in many cases, mold and germ remain together with proteins and fat or oils in addition to a main component such as cellulose in the interior of fibers, when articles are wetted with water and swollen, a spot-like stain is generated by movement of a coloring component and, when articles are left to stand, they are rotten, emit an unpleasant smell and turn black. For these reasons, the vegetable article-containing products must be disposed after use and, from a viewpoint of hygiene and economy and, further, earth environment, a vegetable article-containing product which can be washed with water and used cleanly for a long time has been demanded.

The present invention is intended to provide a vegetable article which can sustain initial characteristics inherent to a product with the use of vegetable articles such as hygroscopicity, texture, favorable smell and appearance and in which deformation, color change and emission of an unpleasant smell due to laundry or water washing are inhibited; a product containing the vegetable article; and a process for producing the vegetable article.

### DISCLOSURE OF THE INVENTION

In order to solve the aforementioned problems, the present inventors continued to intensively study and, as a result, reached the present invention, and adopt the following constitutions. That is:

1. A vegetable article which has been subjected to a crosslinking reaction by using a crosslinking agent so as to inhibit worsening in initial characteristics thereof.

2. A process for producing a vegetable article, comprising: subjecting the vegetable article to a crosslinking reaction by using a crosslinking agent so as to inhibit worsening in initial characteristics thereof.

3. A vegetable article which has been subjected to a crosslinking reaction by using a crosslinking agent, wherein a moisture content change index after washing and dehydration according to JIS L 0217 103 method defined by the following equation is 0.9 or less.
Moisture content change index=A/B

A: Moisture content after one-time washing of crosslinked vegetable article

B: Moisture content after one-time washing of uncrosslinked vegetable article

4. A vegetable article which has been subjected to a crosslinking reaction by using a crosslinking agent, wherein a bulk density change index before washing and after washing and drying according to JIS L 0127 103 method defined by the following equation is 0.7 or less.
Bulk density change index={(C1−C0)/C0}/{(D1−D0)/D0}

C0: Bulk density before washing of crosslinked vegetable article

C1: Bulk density after one-time washing of crosslinked vegetable article

D0: Bulk density before washing of uncrosslinked vegetable article

D1: Bulk density after one-time washing of uncrosslinked vegetable article

5. A vegetable article which has been subjected to a crosslinking reaction by using a crosslinking agent, wherein a lightness (L*) change index before washing and after washing according to JIS L 0217 103 method defined by the following equation is 0.7 or less.
Lightness change index={(E1−E0)/E0}/{(F1−F0)/F0}

E0: L* before washing of crosslinked vegetable article

E1: L* after one-time washing of crosslinked vegetable article

F0: L* before washing of uncrosslinked vegetable article

F1: L* after one-time washing of uncrosslinked vegetable article

6. The vegetable article according to the above 3 or 4, which comprises a fiber aggregate except for a fruit or a husk and a peel of the fruit and a general-purpose natural cellulose fiber.

7. The vegetable article according to the above 3 or 5, which comprises one kind or plural kinds selected from a leaf, a stem, a trunk and a root of a plant.

8. A product comprising the vegetable article according to the above 1 or any one of the above 3 to 7.

### BEST MODE FOR CARRYING OUT THE INVENTION

The present invention will be described specifically below.

A vegetable article in the present invention is a leaf, a stem, a trunk, a vine, a fruit, a husk and a fiber aggregate collected therefrom of a plant such as rush grass, rice plant, luffa, buckwheat, soybean, bamboo, timber or sea grass as a material, and a product containing the same is household goods such as a rush mat, a pillow, a floor cushion, a reed screen, a colander and a sponge, and furniture such as a chair, a wardrobe and a desk. This vegetable article does not contain natural cellulose fibers such as cotton, hemp and linen which are usually used as a general-purpose fiber. In addition, as a material, only these vegetable articles may be used, but they may be used together with cotton, a pad, a thread, a woven fabric, a knitted fabric or a nonwoven fabric obtained from a plastic molded body such as polyester, polyamide, acryl, polyethylene or polypropylene, a natural cellulose fiber such as cotton, hemp or linen, a regenerated cellulose fiber such as viscose method rayon (including polynosic), copper ammonia method rayon or solvent spinning method rayon, and animal hair. Occasionally, materials such as a metal and a mineral may be used.

In the present invention, these vegetable articles are subjected to a crosslinking treatment by using a crosslinking agent. By this crosslinking treatment, a structure composed of cellulose and hemicellulose constituting the vegetable article is crosslinked, swelling due to water is decreased, and deformation and dimensional change are decreased. Further, when heat is used at a crosslinking reaction, by a sterilizing and insecticidal effect with heat, mold or germ and insect and its egg contained in the vegetable article die, initial characteristics such as tone, texture, favorable smell and appearance inherent to a plant is sustained for a long term, and it is considered that prevention of emission of an unpleasant smell and color change of a plant due to water-washing is attained.

The crosslinking treatment in the present invention is carried out by subjecting an active hydrogen group such as a hydroxyl group possessed by cellulose and hemicellulose constituting the vegetable article to the crosslinking treatment by using a crosslinking agent.

Examples of the crosslinking agent which is used in the present invention may include an aldehyde compound, a N-methylol compound, a ketone resin, an acetal resin, an isocyanate compound, an epoxy resin, a polycarboxylic acid compound and the like.

Examples of the aldehyde compound may include formaldehyde, acetoaldehyde, propionaldehyde, glutaraldehyde and the like.

Examples of the N-methylol compound may include formaldehyde resins such as dimethylol urea and a urea formalin condensate; melamine formaldehyde resins such as trimethylol melamine and hexamethylol melamine; cyclic urea compounds such as dimethylol ethylene urea, dimethylol propylene urea, dimethylol dihydroxyethylene urea, dimethylol urone, dimethylol alkyltriazine, tetramethylol acethylene diurea, and 4-methoxy-5-dimethylpropylene urea; a dimethylol hydroxyethyl carbamate-based resin; a polymer of N-methylolacrylamide; and a copolymer of other acryl and methacryl compounds. Alternatively, a methyl ether compound of the above methylol compound is also utilized. Further, a so-called a non-formalin-based resin such as dimethyldihydroxyethylene urea is also used.

Examples of the ketone resin may include an acetone formaldehyde resin and the like.

Examples of the acetal resin may include glycol acetal, pentaerythritol bisacetal and the like.

Examples of the isocyanate-based compound may include compounds having two or more isocyanate groups in a molecule such as tolylene diisocyanate, xylene diisocyanate, diphenylmethane diisocyanate, hexamethylene diisocyanate and isophorone diisocyanate. Alternatively, blocked isocyanate compounds in which plural isocyanate groups are added to a polyol compound and are blocked with sodium sulfite or methyl ethyl ketoxime is used.

Examples of the epoxy resin may include glycidyl ether compounds such as ethylene glycol diglycidyl ether, polyethylene glycol diglycidyl ether, propylene glycol diglycidyl ether, glycerin diglycidyl ether, glycerin triglycidyl ether, polyglycerin polyglycidyl ether, trimethylolpropane triglycidyl ether, sorbitol polyglycidyl ether, and sorbitan polyglycidyl ether.

Examples of the polycarboxylic acid compound may include compounds having plural carboxyl groups, for example, straight chain aliphatic dicarboxylic acid such as oxalic acid, malonic acid, succinic acid, glutaric acid, adipic acid, suberic acid and sebacic acid; unsaturated dicarboxylic acid such as maleic acid, and fumaric acid; alicyclic dicarboxylic acid such as hexahydrophthalic acid, hexahydroisophthalic acid, and hexahydroterephthalic acid; tricarboxylic acid such as tribaric acid, acotinic acid, and methylcyclohexenetricarboxylic acid; tetracarboxylic acid such as butanetetracarboxylic acid, and cyclopentanetetracarboxylic acid; hydroxydicarboxylic acid such as malic acid, tartaric acid, and citric acid; aromatic polycarboxylic acid such as phthalic acid, isophthalic acid, trimellitic acid, and pyromellitic acid; and acryl polymer containing acrylic acid, methacrylic acid and the like.

For these crosslinking agents, a catalyst suitable for each crosslinking agent may be used for the purpose of promoting a reaction, if necessary. For example, when the crosslinking agent is an aldehyde compound or a N-methylol compound, examples of a catalyst may include acidic or potentially acidic catalysts. Examples of the acidic catalyst may include acidic gases such as a hydrogen chloride gas and a SO₂ gas; inorganic acids such as hydrochloric acid, nitric acid, sulfuric acid and phosphoric acid; and organic acids such as glycolic acid, maleic acid, lactic acid, citric acid, tartaric acid and oxalic acid. Examples of the potentially acidic catalyst may include various metal salts (including crystal water-containing salts) such as AlCl₃, Al₂(SO₄)₃, MgCl₂, Mg(H₂PO₄)₂, Zn(BF₄)₂, Zn(NO₃)₂, ZnCl₂, Mg(BF₄)₂, Mg(ClO₄)₂ and Al₂(OH)₄Cl₂; acidic salts of various alkanolamines such as hydrochloride of 2-amino-2-methyl-1-propanol; ammonium salts of strong acids such as nitric acid, hydrochloric acid, sulfuric acid and phosphoric acid; and a mixture thereof. Also in the case where the crosslinking agent is a ketone resin, an acetal resin, an isocyanate compound, an epoxy resin or a polycarboxylic acid compound, a catalyst suitable for each crosslinking agent is utilized.

Examples of a method of giving these crosslinking agents and catalysts to the vegetable article may include a method of contacting a gaseous entity directly with the vegetable article in a vapor phase; and a method of contacting a gaseous entity together with a steam of water or a solvent with the vegetable article. Regarding the liquid or solid entity, a method of dissolving in water or a solvent to immerse the vegetable article in the solution, a method of blowing the solution to the vegetable article by a spraying, and other methods is utilized. Herein, when a form of the vegetable article is chip-like such as a buckwheat husk and rice husk, a method of carrying out a crosslinking agent giving treatment by placing it in a net-like bag is preferably utilized. In the case of a sheet-like entity such as a rush mat of rush grass, the crosslinking agent giving treatment can be carried out as a sheet-like form. In the case of a product such as a wardrobe and a chair containing the vegetable article, the crosslinking agent treatment may be carried out after manufacturing of the product.

After the crosslinking agent and, if necessary, the catalyst are given to the vegetable article or the product containing it, the crosslinking treatment is carried out under suitable conditions for each crosslinking agent. A suitable reaction condition is different depending on a crosslinking agent, and a method of carrying out a heating treatment at 30° C. to 200° C. is preferably utilized. The vegetable article or the product which has been subjected to the crosslinking treatment may be used as it is, or a cleaning treatment may be carried out for the purpose of removing an unreacted crosslinking agent or a remaining catalyst.

A crosslinking effect in accordance with the present invention is simply confirmed specifically by the following method although it cannot be generally described since manifested properties vary depending on a kind of the vegetable article. For example, in the case of a buckwheat husk, a crosslinking effect can be confirmed by placing the buckwheat husk in a bag, washing with water, and measuring a bulk density change rate before and after natural drying. In a normal buckwheat husk, a volume is swollen by the washing treatment, a bulk density is reduced, and its change rate is about 20%. However, in the case of a buckwheat husk which has been subjected to the crosslinking treatment sufficiently in accordance with the present invention, this change rate is 10% or less. In addition, in the case of a rush grass product, the product is immersed in warm water at 40° C. for 30 minutes, and this is naturally dried in the shade, so that a crosslinking effect can be confirmed by whether a change in a color is great or not. In order to know the effect of the present invention more clearly, the effect is expressed by a moisture content change index, a bulk density change index or a lightness change index.

The moisture content change index indicates a ratio of change in a rate of a moisture contained in a vegetable article after washing and dehydration according to JIS L 0217 103 method, of a crosslinked vegetable article and a uncrosslinked vegetable article, and is a value calculated by the following calculating equation.
Moisture content change index=A/B

A: Moisture content after one-time washing of crosslinked vegetable article

B: Moisture content after one-time washing of uncrosslinked vegetable article

The value of less than 1.0 indicates that the crosslinked vegetable article has moisture content after washing and dehydration smaller than that of the uncrosslinked vegetable article. The moisture content change index of less than 1.0 has an effect by crosslinking and, also, has effects that swelling with water at washing is smaller than an unprocessed vegetable article, a change in a shape due to swelling is suppressed, and the article is dried faster. However, in order to sufficiently obtain the effect of the present invention, the moisture content change index is preferably 0.9 or less.

The bulk density change index indicates a ratio of a bulk density change of a vegetable article after washing, dehydration and drying according to JIS L 0217 103 method, of a crosslinked vegetable article and a uncrosslinked vegetable article, and is a value calculated by the following calculating equation.
Bulk density change index={(C1−C0)/C0}/{(D1−D0)/D0}

C0: Bulk density before washing of crosslinked vegetable article

C1: Bulk density after one-time washing of crosslinked vegetable article

D0: Bulk density before washing of uncrosslinked vegetable article

D1: Bulk density after one-time washing of uncrosslinked vegetable article

The bulk density is a value expressing an apparent density of a chip-like vegetable article such as a buckwheat husk, and this measurement is performed by leaving a vegetable article to stand under environment of 20° C. and 65% RH for 24 hours to stabilize a moisture content of the vegetable article, loosely filling the vegetable article in a 1 liter messcylinder, and measuring its weight. Herein, since a difference arises depending on how to fill, a wide funnel is placed at an upper portion of the messcylinder, and it is necessary to drop the vegetable article from a predetermined height every time. In addition, after the vegetable article is filled till a 1000 ml marked line, vibration must not be applied. A weight of thus weighed vegetable article is measured, and a bulk density is calculated by the following equation.
Bulk density (g/ml)=measured weight (g)/1000 (ml)

Since this measurement is accompanied with an error, it is necessary to repeat the measurement at least three times and employ an average value thereof.

The bulk density change index calculated as described above of less than 1.0 indicates that the crosslinked vegetable article has a change in a bulk due to washing smaller than the uncrosslinked vegetable article. The bulk density change index of less than 1.0 has an effect by crosslinking, and indicates that a change in a height due to washing is small when the vegetable article is used as a filler for a pillow or a cushion. However, in order to sufficiently obtain the effect of the present invention, the bulk density change index is preferably 0.7 or less.

The lightness change index is a value indicating a ratio of color change after washing, dehydration and drying according to JIS L 0217 103 method of a crosslinked vegetable article and a uncrosslinked vegetable article. The color of the vegetable article can be measured with a differential colorimeter. There are various units for a color which is measured with the differential colorimeter, but a method using L*(lightness) of CIE1976 L*a*b* color specification system is convenient. This is because, in most cases of color change in the vegetable article due to washing, the color is wholly lightened or the color becomes wholly blackish, and a degree of color change has a very high correlation with lightness. The lightness change index is a value calculated by the following equation.
Lightness change index={(E1−E0)/E0}/{(F1−F0)/F0}

E0: L* before washing of crosslinked vegetable article

E1: L* after one-time washing of crosslinked vegetable article

F0: L* before washing of uncrosslinked vegetable article

F1: L* after one-time washing of uncrosslinked vegetable article

The lightness change index of less than 1.0 indicates that there is an effect by crosslinking and color change after washing is smaller than that in an unprocessed vegetable article. However, in order to sufficiently obtain the effect of the present invention, it is preferable that the lightness change index is 0.7 or less.

By subjecting the vegetable article to the crosslinking treatment by using the crosslinking agent as described above, it becomes possible to produce a vegetable article and a vegetable article-containing product which sustain initial characteristics thereof.

### EXAMPLES

Hereinafter, the present invention will be described specifically by way of examples; however, the present invention is not limited to these examples. Evaluation methods used in the examples will be shown below.

(Washing method): Washing and dehydration according to JIS L 0217 103 method. In the case of a chip-like vegetable article such as a buckwheat husk, a washing treatment was carried out by placing the article in a bag made of a No. 50 cotton broad cloth which had been subjected to a refining and bleaching treatment. In the case of a sheet-like article, a sheet having a size of 20×20 cm in which a periphery had been subjected to lock sewing was used. In this example, a 2-bath washing machine (CW-S30) manufactured by Mitsubishi Electric Corporation was used as a washing machine.

(Moisture content): A vegetable article after washing and dehydration according to JIS L 0217 103 method was thoroughly dried at 105° C. for 2 hours, and a moisture content was calculated from weights before and after thoroughly drying treatment.
Moisture content (%)=(weight after dehydration−weight after thoroughly drying) weight after thoroughly drying×100

(Moisture content change index): A moisture content change index was calculated from the following equation from moisture contents before crosslinking treatment and after crosslinking treatment of the same vegetable article. It is indicated that as a moisture content change index is less than 1.0 and smaller, a moisture content after washing and dehydration of the vegetable article is reduced by the crosslinking treating.
Moisture content change index=A/B

A: Moisture content after one-time washing of crosslinked vegetable article

B: Moisture content after one-time washing of uncrosslinked vegetable article

(Bulk density): A chip-like vegetable article such as a buckwheat husk was left to stand under the environment of 20° C. and 65% RH for 24 hours, and loosely filled in a 1 liter messcylinder, and its weight was measured, this was repeated five times, and an average value of the weight was employed, and a bulk density was measured by the following equation.
Bulk density (g/ml)=measured weight (g)/1000 (ml)

(Bulk density change index): From a bulk density obtained regarding a vegetable article which had been dried in a hot air dryer at 30° C. before crosslinking treatment and after crosslinking treatment of the same vegetable article, and before washing and after washing and dehydration according to JIS L 0217 103 method, a bulk density change index was calculated by the following equation.
Bulk density change index={(C1−C0)/C0}/{(D1−D0)/D0}

C0: Bulk density before washing of crosslinked vegetable article

C1: Bulk density after one-time washing of crosslinked vegetable article

D0: Bulk density before washing of uncrosslinked vegetable article

D1: Bulk density after one-time washing of uncrosslinked vegetable article

It is indicated that, when the bulk density change index is less than 1.0 and is smaller, the bulk density change by washing of the vegetable article is reduced by the crosslinking treatment.

(Drying time): After a vegetable article-containing product is left to stand under the environment of 20° C./65% RH for 24 hours, and a total weight is measured. Thereafter, the vegetable article-containing product is subjected to washing and dehydration according to JIS L 0217 103 method, and a weight is measured again. Thereafter, the vegetable article-containing product is hung in a hot air dryer having an exhaust opening set at 30° C., a weight is measured with time, and a time until a weight is returned to a weight before washing is measured.

(Color migration): A vegetable article was placed in a bag made of a cotton broad cloth after refining and bleaching, was washed according to JIS L 0217 103 method, and was hung and dried in a hot air dryer having an exhaust opening set at 30° C. Thereafter, whether a color of the vegetable article is migrated to the cotton cloth or not was evaluated based on the following.

◯: Color migration is not seen at all.

Δ: Color migration is slightly seen.

×: Color migration is considerably seen.

(Washing discoloration): A lightness (L*) of a vegetable article which had been dried in a hot air dryer having an exhaust opening set at 30° C. was measured with a differential colorimeter (Macbeth COLOR-EYE) before washing and after washing and dehydration according to JIS L 0217 103 method, to obtain an L* value.

(Lightness change index): A lightness change index was calculated by the following equation from the L* value (lightness) obtained in the above process (Washing discoloration). When the lightness change index is less than 1.0 and is smaller, it indicates that the color change in the vegetable article due to washing is reduced by a crosslinking treatment.
Lightness change index={(E1−E0)/E0}/{(F1−F0)/F0}

E0: L* before washing of crosslinked vegetable article

E1: L* after one-time washing of crosslinked vegetable article

F0: L* before washing of uncrosslinked vegetable article

F1: L* after one-time washing of uncrosslinked vegetable article

(Washing smell): A smell of a vegetable article after drying in a hot air dryer having an exhaust opening set at 30° C. was sniffed before washing and after washing and dehydration according to JIS L 0217 103 method, and a change in a smell was determined based on the following.

◯: There is no change from before washing.

Δ: Amount of smell was changed from before washing, but there is no change in quality of smell.

×: Smell was changed to smell of different quality as compared with before washing.

### Examples 1 to 4, Comparative Examples 1 and 2

### Example 1

400 g of a buckwheat husk was placed in a bag with a size of 30×40 cm made of a polyester 30 mesh cloth, was immersed in 3 liter of a liquid containing a dimethyloldihydroxyethylene urea-based crosslinking agent and a magnesium chloride-based catalyst of (Formulation 1) for 10 minutes, and was dehydrated by centrifugation so that an amount of a formulation liquid to be given to the buckwheat husk became 80% by weight. Then, the buckwheat husk in the bag was transferred to a stainless vat, this was flattened so that a thickness thereof became 2 cm or less, this was dried in a hot air dryer at 105° C. for 30 minutes, and was subjected to a heat treatment in a hot air dryer at 150° C. for 30 minutes to carry out a crosslinking reaction. The buckwheat husk after the crosslinking reaction was placed in the mesh bag again, this was immersed in 20 liter of water, mildly stirred for 3 minutes, and a water washing treatment of centrifugation and dehydration was carried out two times, and this was transferred to the stainless vat, and dried in a hot air dryer at 105° C. for 1 hour. 300 g of thus obtained buckwheat husk was placed in a bag with a size of 25×35 cm made of a No. 50 cotton broad cloth, having a fastener equipped with a lock, to make a buckwheat husk pillow.

(Formulation 1)

| | |
|---|---|
| Sumitex Resin NS-19 | 15 parts by weight |
| Sumitex Accelerator MX | 6 parts by weight |
| Water | 79 parts by weight |

### Example 2

400 g of a buckwheat husk was placed in a cylindrical bag with a diameter of 10 cm and a length of 50 cm made of a polyester 30 mesh cloth, the bag was hung in a sealed container of a volume of 1 m³ having a structure by which the pressurized air can be exhausted, 1 liter of a formalin liquid containing 37% of formaldehyde together with a steam was blown through a spray nozzle, a sulfur dioxide gas was blown into the container, and a crosslinking reaction was performed over 30 minutes while maintaining an internal temperature of 90° C. Thereafter, a steam was blown for 30 minutes while replacing the air in the interior of the sealed container, and the bag was taken out from the sealed container. Thereafter, the polyester mesh bag containing the buckwheat husk which had been subjected to the crosslinking treatment with formaldehyde was immersed in 20 liter of water, and this was slightly stirred for 3 minutes, a water washing treatment of centrifugation and dehydration was carried out two times, and transferred to a stainless vat, and this was dried in a hot air dryer at 105° C. for 1 hour. 300 g of this buckwheat husk was placed in a bag having a fastener equipped with a lock with a size of 25×35 cm made of a No. 50 cotton broad cloth, to make a buckwheat husk pillow.

### Comparative Example 1

300 g of a buckwheat husk which had not been subjected to treatment was placed in a bag with a size of 25×35 cm made of a No. 50 cotton broad cloth, having a fastener equipped with a lock, to make a buckwheat husk pillow.

A moisture content, a moisture content change index, a drying time, a bulk density, a bulk density change index, color migration, and a washing smell of each buckwheat husk pillow of Examples 1, 2 and Comparative Example 1 were evaluated, and are summarized in (Table 1).

TABLE 1

| | | | Comparative |
|---|---|---|---|
| Processing conditions | Example 1 | Example 2 | Example 1 |
| Moisture content | 58% | 62% | 78% |
| (% by weight) | | | |
| Moisture content | 0.74 | 0.79 | — |
| change index | | | |
| Drying time | 6 hours | 7 hours | 10 hours |
| Bulk density before | 0.108 | 0.096 | 0.105 |
| washing (g/ml) | | | |
| Bulk density after | 0.105 | 0.093 | 0.095 |
| washing (g/ml) | | | |
| Bulk density change | 0.29 | 0.33 | — |
| index | | | |
| Color migration | ◯ | ◯ | X |
| Washing smell | ◯ | ◯ | X |

From the results of (Table 1), it can be seen that the buckwheat husk pillows of Examples 1 and 2 of the present invention have a small moisture content after washing and dehydration, and they were dried fast. In addition, it is obvious that a change in a bulk density before and after washing is small. Further, there is no color migration to a cloth, and no change in smell, and it is clear that those pillows retain preferable characteristics as a buckwheat husk pillow after washing. To the contrary, in the buckwheat husk pillow of Comparative Example 1 which has not been subjected to the crosslinking treatment, a moisture content after washing and dehydration is high, drying needs much time, a bulk density is reduced after washing, a color of the buckwheat husk is migrated to a cotton cloth, quality of smell of the buckwheat husk is changed; thus, the pillow was hardly used as a repeatedly washable buckwheat husk pillow.

### Example 3

A rush mat of rush grass was cut into a size of 20×20 cm, and a sample in which a periphery was lock-sewn was made. This was immersed in 1 liter of a liquid containing a dimethyloldihydroxyethylene urea-based crosslinking agent and a magnesium chloride-based catalyst of (Formulation 2) for 10 minutes, and centrifuged and dehydrated so that an amount of a formulation liquid to be given to the rush grass became 70% by weight. Then, the sample was dried in a hot air dryer at 120° C. for 2 minutes, and was subjected to a heat treatment in the hot air dryer at 150° C. for 3 minutes to perform a crosslinking reaction. The rush grass sample after the crosslinking reaction was immersed in 20 liter of water, this was slightly stirred for 3 minutes, and a water-washing treatment of centrifugation and dehydration was carried out two times, and this was dried at 120° C. for 2 minutes. Like this, a rush mat sample of the rush grass was obtained.

(Formulation 2)

| | |
|---|---|
| Sumitex Resin NS-19 | 10 parts by weight |
| Sumitex Accelerator MX | 4 parts by weight |
| Water | 86 parts by weight |

### Example 4

A rush mat of rush grass was cut into a size of 20×20 cm, and a sample in which a periphery was lock-sewn was made. This was immersed in 1 liter of a liquid containing formalin and a magnesium chloride-based catalyst of (Formulation 3), and centrifugal drying so that an amount of a formulation liquid to be given to the rush grass became 70% by weight. Then, the sample was subjected to a heat treatment in a hot air dryer at 150° C. for 4 minutes to perform a crosslinking reaction. The rush grass sample after the crosslinking reaction was immersed in 20 liter of water, this was slightly stirred for 3 minutes, and a water-washing treatment of centrifugation and dehydration was carried out two times, and this was dried at 120° C. for 2 minutes. Like this, a rush mat sample of the rush grass was obtained.

(Formulation 3)

| | |
|---|---|
| Formalin (37% formaldehyde solution) | 8 parts by weight |
| Sumitex Accelerator X-110 | 3 parts by weight |
| Water | 11 parts by weight |

### Comparative Example 2

A rush mat of rush grass which had not been subjected to treatment was cut into a size of 20×20 cm, and a rush mat sample of the rush grass in which a periphery was lock-sewn was prepared.

A moisture content, a moisture content change index, washing discoloration, a drying time, a lightness, a lightness change index, and a washing smell of each rush mat sample of the rush grass of Examples 3, 4 and Comparative Example 2 were evaluated, and are summarized in (Table 2).

TABLE 2

| | | | Comparative |
|---|---|---|---|
| Processing conditions | Example 3 | Example 4 | Example 2 |
| Moisture content | 41% | 40% | 53% |
| (% by weight) | | | |
| Moisture content | 0.77 | 0.75 | — |
| change index | | | |
| Drying time | 40 minutes | 40 minutes | 60 minutes |
| L* before washing | 73.2 | 73.5 | 74.6 |
| L* after washing | 72.0 | 72.4 | 71.0 |
| Lightness change | 0.34 | 0.31 | — |
| index | | | |
| Washing smell | ◯ | ◯ | Δ |

From the results of (Table 2), it can be seen that the rush mat samples of the rush grass of Examples 3 and 4 of the present invention have a small moisture content after washing and dehydration, and they were dried fast. In addition, it is obvious that a change in color before and after washing is small. Further, a change in smell is small, and it is clear that they maintain preferable characteristics as a rush mat of rush grass after washing. To the contrary, it is seen that, in the rush mat sample of the rush grass of Comparative Example 2 which has not been subjected to the crosslinking treatment, a moisture content after washing and dehydration is high, drying needs a time, a color turned blackish after washing, and a smell of rush grass is decreased.

### INDUSTRIAL APPLICABILITY

According to the present invention, it has became possible to provide a stable vegetable article which sustain initial characteristics such as hygroscopicity, texture, favorable smell and appearance that are features of a product using the vegetable article, and in which deformation, color change and emission of unpleasant smell due to laundry and water washing are inhibited, a vegetable article-containing product, and a process for producing the vegetable article.

1. A vegetable article which has been subjected to a crosslinking reaction by using a crosslinking agent so as to inhibit worsening in initial characteristics thereof.

2. A process for producing a vegetable article, comprising:
subjecting the vegetable article to a crosslinking reaction by using a crosslinking agent so as to inhibit worsening in initial characteristics thereof.

3. A vegetable article which has been subjected to a crosslinking reaction by using a crosslinking agent, wherein a moisture content change index after washing and dehydration according to JIS L 0217 103 method defined by the following equation is 0.9 or less.
Moisture content change index=A/B
A: Moisture content after one-time washing of crosslinked vegetable article
B: Moisture content after one-time washing of uncrosslinked vegetable article

4. A vegetable article which has been subjected to a crosslinking reaction by using a crosslinking agent, wherein a bulk density change index before washing and after washing and drying according to JIS L 0127 103 method defined by the following equation is 0.7 or less.
Bulk density change index={(C1−C0)/C0}/{(D1−D0)/D0}
C0: Bulk density before washing of crosslinked vegetable article
C1: Bulk density after one-time washing of crosslinked vegetable article
D0: Bulk density before washing of uncrosslinked vegetable article
D1: Bulk density after one-time washing of uncrosslinked vegetable article

5. A vegetable article which has been subjected to a crosslinking reaction by using a crosslinking agent, wherein a lightness (L*) change index before washing and after washing according to JIS L 0217 103 method defined by the following equation is 0.7 or less.
Lightness change index={(E1−E0)/E0}/{(F1−F0)/F0}
E0: L* before washing of crosslinked vegetable article
E1: L* after one-time washing of crosslinked vegetable article
F0: L* before washing of uncrosslinked vegetable article
F1: L* after one-time washing of uncrosslinked vegetable article

6. The vegetable article according to claim 3, which comprises a fiber aggregate except for a fruit or a husk and a peel of the fruit and a general-use natural cellulose fiber.

7. The vegetable article according to claim 4, which comprises a fiber aggregate except for a fruit or a husk and a peel of the fruit and a general-use natural cellulose fiber.

8. The vegetable article according to claim 1, which comprises one kind or plural kinds selected from a leaf, a stem, a trunk and a root of a plant.

9. The vegetable article according to claim 5, which comprises one kind or plural kinds selected from a leaf, a stem, a trunk and a root of a plant.

10. A product comprising the vegetable article according to claim 1.
